(19) United States
(12) Patent Application Publication
(10) Pub. No.: US 2008/0109429 A1
(43) Pub. Date: May 8, 2008

(54) METHOD AND SYSTEM FOR ELECTRONIC COMMUNICATION

(76) Inventor: Lorenzo W. Petrin, Calgary (CA)

Correspondence Address: FISH & RICHARDSON P.C., PO BOX 1022, MINNEAPOLIS, MN, 55440-1022, US

(21) Appl. No.: 11/549,901

(22) Filed: Oct. 16, 2006

(51) Int. Cl. G06F 17/30

(52) U.S. Cl. 707/6; 340/7.23; 706/48; 455/414.1

(57) ABSTRACT

A method and system for facilitating electronic communication between two or more people is described. In one implementation, a first encounter description is received from a first user, the first encounter description including content describing an encounter between the first user and a second user. A search query is formulated based on the first encounter description. The search query is used to search a collection of received encounter descriptions to match at least some of the content of the first encounter description with content of one or more other received encounter descriptions. One or more other received encounter descriptions are identified matching the first encounter description based on the search, including a second encounter description from the second user comprising content describing the encounter between the first user and the second user. Notification is provided to the first user of the second encounter description.

### TECHNICAL FIELD

This invention relates to facilitating electronic communication between two or more people.

### BACKGROUND

People encounter dozens if not hundreds of different people every week as they go about their busy lives. Patrons at restaurants, service staff at stores, travelers on the subway, and fellow students at a university are just some examples of the types of people we may encounter in a single day. However, meeting new people can often be difficult, as strangers generally keep to themselves, particularly in high density urban centers. Dating services have seen a surge in popularity, particularly online dating services that provide users with convenient access to information about potential new relationships. Conventional dating services are directed to introducing two people who would appear to have common interests but have never met, seen nor encountered one another before.

### SUMMARY

This invention relates to a method and system for facilitating electronic communication between two or more people. In general, in one aspect, the invention includes a computer implemented method for facilitating an electronic communication between a first and a second user. A first encounter description is received from a first user, the first encounter description including content describing an encounter between the first user and a second user. A search query is formulated based on the first encounter description. The search query is used to search a collection of received encounter descriptions to match at least some of the content of the first encounter description with content of one or more other received encounter descriptions. One or more other received encounter descriptions are identified matching at least some of the content of the first encounter description based on the search, including a second encounter description from the second user comprising content describing the encounter between the first user and the second user. Notification is provided to the first user of the second encounter description.

Implementations of the invention may include one or more of the following features. Formulating the search query can be in response to receiving the first encounter description. The first encounter description can be added to the collection of received encounter descriptions. An encounter description can include a time of the encounter, a location of the encounter and the gender of the second user. A first user profile can be received from the first user, where the user profile includes personal information about the first user, and formulating the search query can include formulating the search query based on the first encounter description and the first user profile.

A request can be received from the first user to contact the second user, and a message input can be received from the first user and transmitted to the second user. A response can be received from the second user to the message input of the first user, and the response can be transmitted from the second user to the first user.

Notification can be provided to the second user of the first encounter description. A request from the second user to contact the first user can be received as well as a message input from the second user. The message input can be transmitted to the first user. A response can be received from the first user to the message input of the second user and transmitted to the second user.

Receiving a first encounter description from a first user can include receiving at least one of the following from the first user: a text message, an email message, an instant message, an audio message, a communication through a mobile application installed on a mobile device, or a posting to a website. Where receiving a first encounter description from a first user includes receiving an audio message, the audio message can be translated into text. The encounter between the first user and the second user can include, for example: a sighting between the first and second users; an interaction between the first and second users; a past or current relationship between the first and second users; and/or an in-person connection between the first and second users.

Providing notification to the first user of the second encounter description can include providing at least one of the following to the first user: a text message, an instant message, an email message, an audio message, a communication through a mobile application installed on a mobile device, or a textual display on a graphical user interface of a webpage displayed to the first user.

Using the search query to search a collection of received encounter descriptions to match the content of the first encounter description with content of one or more other received encounter descriptions can include performing a text-based search of the collection of received encounter descriptions for content satisfying one or more search criteria based on the content of the first encounter description. The first encounter description including content describing an encounter between the first user and a second user can include a plurality of values completing a plurality of data fields. Formulating a search query based on the first encounter description can include formulating a field-based query based on the plurality of data fields. Using the search query to query the collection of received encounter descriptions can include using the field-based query to query the plurality of data fields included in each of the received encounter descriptions on a field-by-field basis.

Using the search query can further include using the search query to query a plurality of data fields included in user profiles included in a collection of user profiles, where each encounter description included in the collection of received encounter descriptions corresponds to a user profile included in the collection of user profiles.

A selection from the first user of a desired accuracy level can be received and can be used with the search query to search the collection of received encounter descriptions and identify matching encounter descriptions.

In general, in another aspect, the invention includes a system for facilitating an electronic communication between a first and a second user. The system includes a user interface, a collection of received encounter descriptions and a matching engine. The user interface is configured to: receive an encounter description from a user including a first encounter description received from a first user including content describing an encounter between the first user and a second user; and provide notification to the first user of a second encounter description including content describing the encounter between the first user and the second user. Each encounter description included in the collection of received encounter descriptions includes content describing an encounter between two different users. The matching engine is configured to formulate a query based on the first encounter description and to use the search query to search the collection of received encounter descriptions for one or more received encounter descriptions including content matching the content of the first encounter description.

Implementations of the invention can include one or more of the following features. The system can further include a collection of user profiles, each user profile including personal information about a user and the collection including a first user's profile corresponding to the first user. The matching engine can be further configured to formulate the query based on both the first encounter description and the first user's profile. The matching engine can be further configured to use the search query to search both the collection of received encounter descriptions and the collection of user profiles for one or more received encounter descriptions and corresponding user profiles that include content matching at least some of the content of the first encounter description.

The user interface can be configured to receive an encounter description including at least one of the following: a text message, an email message, an instant message, a website posting, a communication from a mobile application installed on a mobile device or an audio message. If the user interface is configured to receive an encounter description in the form of an audio message, the system can further include an audio translation engine configured to translate the audio message into text.

The user interface can be configured to provide notification to the first user by providing at least one of the following to the first user: a text message, an email message, an instant message, an audio message, a communication to a mobile application installed on a mobile device, or a textual display on a graphical user interface of a webpage displayed to the first user.

Examples of encounters between the first user and the second user include: a sighting between the first and second users; an interaction between the first and second users; a past or current relationship between the first and second users and/or an in-person connection between the first and second users.

In general, in another aspect, the invention features a computer implemented method for facilitating an electronic communication between a first and a second user. A first encounter description is received from a first user, the first encounter description including content describing an encounter between the first user and a second user. A search query is formulated based on the first encounter description. The search query is used to search a collection of user profiles to match at least some of the content of the first encounter description with content included in one or more user profiles, where a user profile includes personal information about a user. One or more user profiles matching at least some of the content of the first encounter description based on the search are identified, including a second user's profile for the second user. The second user's profile includes content matching at least some of the content of the first encounter description. Notification is provided to the first user of a match to the second user.

Implementations of the invention can include one or more of the following features. The first encounter description including content describing an encounter between the first user and a second user can include a plurality of values completing a plurality of encounter description data fields. A user profile can include a plurality of values completing a plurality of user profile data fields. At least some of the encounter description data fields can correspond to the user profile data fields. Formulating a search query based on the first encounter description can include formulating a field-based query based on the plurality of encounter description data fields. Using the search query to query the collection of user profiles can include using the field-based query to query the user profile data fields corresponding to the encounter description data fields on a field-by-field basis. Notification can be provided to the second user of a match of the second user's profile to the first encounter description.

Implementations of the invention can realize one or more of the following advantages. Someone who feels they missed an opportunity to meet someone else whom they encountered, for example, by a sighting, interaction or otherwise, can employ the method and system described herein to attempt to identify that other person. If the person is identified, electronic communication between the two people is facilitated, including anonymous or direct contact. If each person entered an encounter description into the system describing the same encounter, and the encounter descriptions are matched leading to the electronic communication between the two people, then connection is mutual and provides a basis for subsequent communication.

The techniques described herein provide a quick and reliable way for two people who are attempting to make contact, but do not have each other's contact information or would prefer to initiate contact anonymously, to enter into electronic communication. Additionally, the communication can be private and discrete, with messages flowing privately between two people, as compared to a non-private setting such as an Internet bulletin board or chat room. By providing various different ways of electronically communicating with the system, a user can conveniently input an encounter description immediately after or even during an encounter and similarly can receive immediate results, for example, by using a PDA or mobile telephone. By contrast to a conventional dating service, the system promotes electronic communication between two people who have had some prior encounter, whether it be merely a sighting or perhaps a conversation. Something exists between the two (or more) people that has sparked an interest to pursue contact, whether the motivation is romantic or otherwise, as compared to an arbitrary pairing by a dating service of two complete strangers. When the system is implemented using electronic communication over the Internet, an “online” communication can result following an initial “offline” connection, in direct contrast to an online dating service, for example, that strives toward the reverse; i.e., an offline communication initiated by an online pairing.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a schematic representation of a system that can facilitate electronic communication between two users.

FIG. 2 is a flowchart showing a process for facilitating electronic communication between two users.

FIG. 3 is a table showing one implementation of member information that can be gathered from a user of a system for facilitating electronic communication between two users.

FIG. 4 is a table showing one implementation of encounter description information that can be received from a user of a system for facilitating electronic communication between two users.

FIG. 5 is a table showing one implementation of relationship descriptors that can be included in an encounter description.

FIG. 6 is a schematic representation in tabular form of matching variables between two encounter descriptions into a system for facilitating electronic communication between two users.

FIG. 7 is an example of a connection message sent to a user of a system for facilitating electronic communication between two users.

FIG. 8 is an example of information that can be presented to a user of a system for facilitating electronic communication between two users detailing the user's inputs of encounter descriptions.

FIG. 9 is an example of information that can be presented to a user of a system for facilitating electronic communication between two users detailing encounter description authored by other users that match the user's input of an encounter description.

FIG. 10 is an example of a graphical user interface that can be presented to a user of a system for facilitating electronic communication between two people to prompt the user to compose a message to another user.

FIG. 11 is an example of a message that can be sent to a user of a system for facilitating electronic communication between two people notifying the user of a message received from another user who authored a matching encounter description.

FIG. 12 is an example of a message that can be sent to a user of a system for facilitating electronic communication between two people notifying the user of a message received from another user who authored a matching encounter description and who seeks direct contact.

Like reference symbols in the various drawings indicate like elements.

### DETAILED DESCRIPTION

This disclosure describes a computer implemented method and system for facilitating an electronic communication between a first and a second user following an “encounter”. An encounter is any connection between the first and the second user. Generally the connection is offline, meaning the connection between the two users is something other than an online connection, such as a connection made through a chat room or bulletin board on the Internet. Some examples of encounters include a sighting (e.g., face to face contact between two strangers), an interaction (e.g., a brief conversation), or a relationship either past or current (e.g., a long-ago relationship).

Generally, a first user inputs a first encounter description to the system describing an encounter with another person. A collection of previously received encounter descriptions, also describing encounters between two or more people, is searched to determine if one or more of the received encounter descriptions “matches” the first encounter description. Various criteria that can be used to define what constitutes a “match” is described further below. Matching encounter descriptions are identified based on the search, and the first user is provided with notification of the matches. For example, if the person with whom the first user had the encounter was also a user of the system, i.e., the “second user”, and the second user had input an encounter description that described the same encounter from the second user's perspective (i.e., a “second encounter description”), then assuming the two descriptions of the single encounter were sufficiently similar in content, a match between the first encounter description and the second encounter description would be made. It is also possible that other matches will be identified if the content describing two encounters is similar, even though the two users are in fact describing different encounters possibly with different people, i.e., false positive matches.

For illustrative purposes, consider the following example. The “first user” may be a man who has just seen (and possibly briefly spoken to) an interesting woman in a coffee shop. The man's input into the system includes a description of the encounter between him and the interesting woman. Similarly, the interesting woman, having briefly talked to the same man at the coffee shop, may also decide to use the system to enter a detailed description of her encounter (i.e., the woman is the “second user”). Subsequently, the system searches a collection of received encounter descriptions looking to match the content of the first encounter description with content of one or more other received encounter descriptions. The search can compare the description of the man's encounter with the descriptions of other users' encounters, most of which are likely to be unrelated to the man's encounter. Various search criteria can be used, as discussed further below, and one or more matching encounter descriptions identified. Assuming the woman described the encounter in a sufficiently similar manner as the man, the woman's encounter description is identified as a match and the system notifies the man of the woman's description (i.e., the “second encounter description”). The man is also given the opportunity to electronically communicate with the woman.

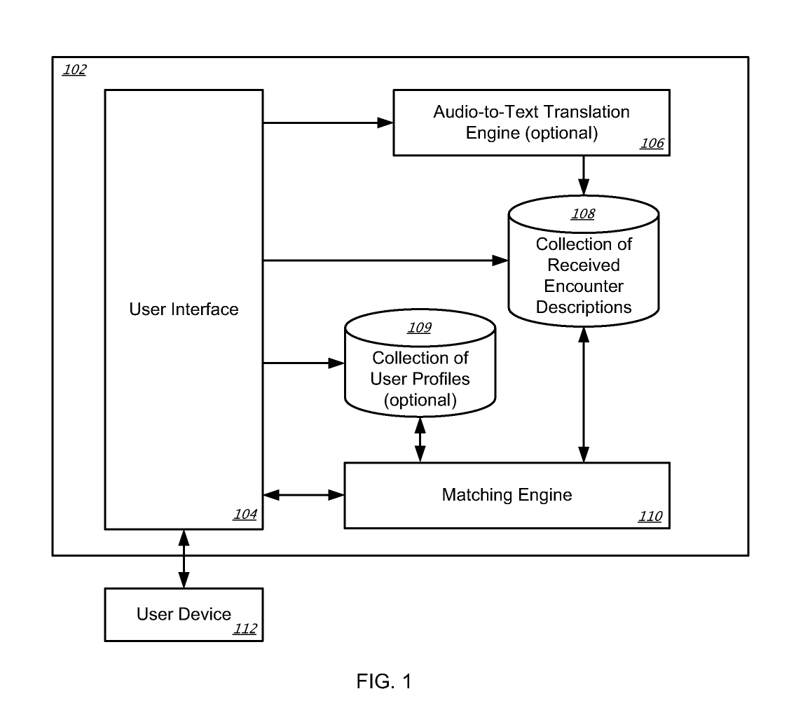

FIG. 1 is a schematic diagram showing one example implementation of an electronic communication system 102 that facilitates communication between two users following an “encounter”. In this implementation, the system 102 includes a user interface 104, an optional audio-to-text translation engine 106, a collection of received encounter descriptions 108, an optional collection of user profiles 109, and a matching engine 110. The system 102 can interface with a user by way of a user device 112.

The user interface 104 can process inputs received from, and transmit information to, a user using the user device 112. For example, the user can employ the user device 112 to enter a description of an encounter, such as the man's encounter with the interesting woman at a coffee shop. The information can be received by the user interface 104, which can include and execute application software to process the information.

In one implementation, the user interface 104 is implemented as a graphical user interface (GUI) presented to a user on one or more webpages accessible via the Internet, for example, by inputting a Uniform Resource Locator (URL) of a website into a web browser. The user can post a description of an encounter to the user interface 104 by interaction with the GUI.

In one implementation, the user interface 104 includes software, firmware and/or hardware configured to receive audio input from the user via a telephone line. In this implementation, the system 102 can include the optional audio-to-text translation engine 106 configured to translate the received audio input into text. The user can access the user interface 104 using a telephone (i.e., the user device 112 can be implemented as a telephone).

In one implementation, the user interface 104 includes software, firmware and/or hardware configured to receive text messages (also known as short messages) from a user device 112 configured to send text messages, e.g., a mobile telephone. The user interface 104 also can be configured to send text messages to the user device 112.

In another implementation, the user interface 104 includes software, firmware and/or hardware configured to receive instant messages from a user device 112 configured to send instant messages, e.g., a computer. The user interface 104 also can be configured to send instant messages to the user device 112.

In another implementation, the user interface 104 includes software, firmware and/or hardware configured to receive e-mails messages from a user device 112 configured to send e-mail messages, e.g., a computer. The user interface 104 also can be configured to send e-mail messages to the user device 112.

In another implementation, if the user device 112 is a mobile device, then a user can interact with the system 102 through a mobile application. The mobile application can be downloaded and installed on the user device 112 (e.g., cell phone, personal digital assistant) before the user can interact with the system 102 through the mobile application. The mobile application provides a special purpose rich user interface for inputting encounter descriptions and messages to the system 102, viewing data received from the system 102, for example, encounter descriptions, matching encounter descriptions, messages from matched users, and notifications from the system, and for accessing other functionality supported by the system 102.

In other implementations, the user interface 104 can be configured to interact with the user by way of all or some of the mechanisms discussed above, as well as other forms of communication, in particular, electronic communication. The examples described above are illustrative and not intended to be exhaustive.

The system 102 includes a collection of received encounter descriptions 108. The collection includes encounter descriptions received from users by way of the user interface 104 describing encounters. The collection of received encounter descriptions 108 can be implemented, for example, as a series of databases or other files accessible locally or remotely by the user interface 104. For example, if the user interface 104 is implemented within a website, then application software executing the website can include software for accessing the collection of received encounter descriptions 108. The content of the encounter descriptions 108 can be stored, for example, using a relational data base management system (RDBMS), as well as other data storage systems, including files that can contain metadata. Such data storage systems can facilitate efficient searches to match received encounter descriptions of mutually-interested users. Additionally, the collection of received encounter descriptions 108 can also include user profile information, or alternatively user profile information can be stored separately, e.g., in the optional collection of user profiles 109 shown in FIG. 1. The system 102 can also rely on cookies stored on individual users' computers to store user profile information, such as data that can facilitate a user's ongoing interactions with the system's website.

The matching engine 110 can include software, firmware and/or hardware configured to search the collection of received encounter descriptions 108 for content included in said collection that matches content included in a particular received encounter description. In one implementation, the matching engine 110 uses a received encounter description, e.g., the first encounter description, to formulate a text-based query that is used to query the collection of received encounter descriptions 108. The matching engine 110 can be implemented, for example, using a combination of customized and commercially available software. For example, the matching engine 110 can use an RDBMS similar to that used to store the collection of received encounter descriptions 108. The matching engine 110 can also use indexes and metadata corresponding to the collection of received encounter descriptions 108 when executing a search.

In one implementation, the encounter description includes values completing a number of data fields, e.g., a time field, a location field, a first user appearance field and a second user appearance field. The search query that is formulated based on an encounter description can be a field-based query. That is, the query is searching for content in the “time field” that matches the content input by the first user in the time field describing the encounter. Different techniques and criteria can be used for identifying a positive match, whether using a field-based approach or not. Some example techniques include requiring an exact match, using a natural language algorithm and/or using Soundex. Soundex is a phonetic algorithm indexing words by their sound when pronounced. The basic aim is for words with the same pronunciation to be encoded to a same string so that matching can occur despite minor differences in spelling, e.g., spelling mistakes. Other techniques for searching and matching data can be used.

In one implementation, the matching engine 110 can handle search queries including ranges. For example, in the time field the first user may have input a range of 3:00-5:00 pm. If a received encounter description included 4:00 pm in the time field, then a match with respect to the time field is made. By contrast, if the search were strictly text based without range capabilities, then a match may not have been made, as 4:00 does not match either 3:00 or 5:00.

An additional advantage to a field based query is illustrated in the following example. If the first user inputs into a first user appearance field “brown hair” and inputs into a second user appearance field “blond hair”, that is, the brown haired user had an encounter with a blond haired second user, then when a search is conducted of the received encounter descriptions, “brown hair” must be found in the appropriate data field for there to be a match. That is, the first user is only interested in finding encounter descriptions authored by someone with “blond hair” who had an encounter with someone with “brown hair”. Using a field-based search can effectively screen out encounter descriptions authored by someone with “brown hair” who had an encounter with someone with “blond hair”, thereby reducing the number of false matches.

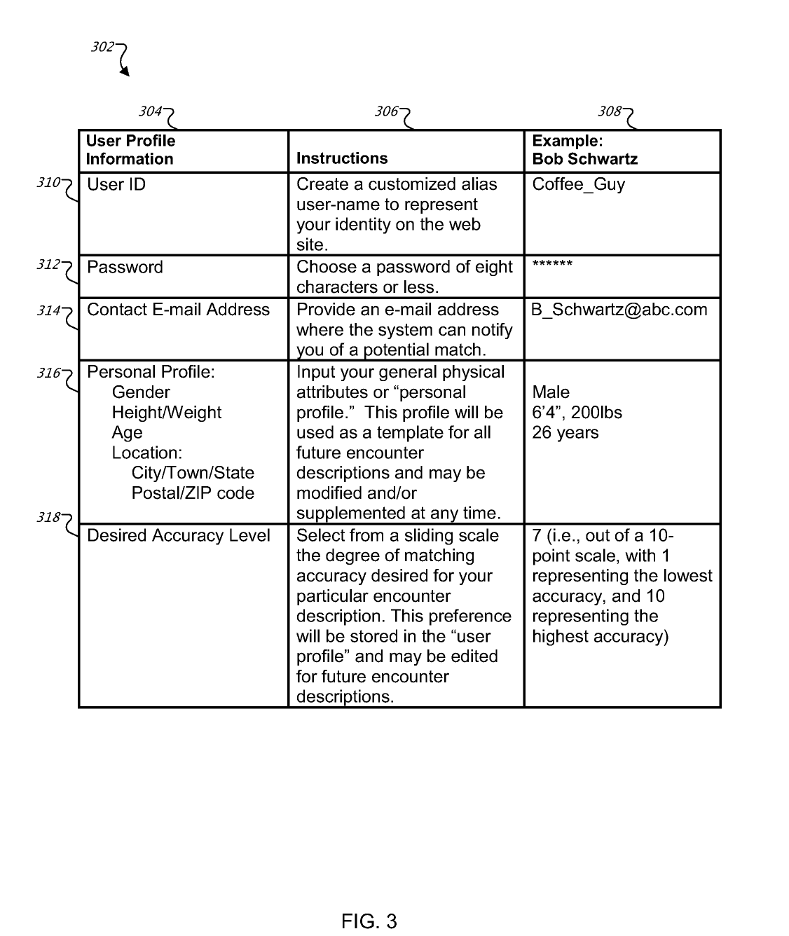

In one implementation, the search query can be formulated based on the encounter description and previously acquired user profile information about the user that input the encounter description. That is, in a system including the optional collection of user profiles 109 (FIG. 1), information about the first user can be retrieved from the first user's profile included in the optional collection of user profiles 109. This information can be used to formulate the search query, in addition to using the encounter description input by the first user. The first user can thereby avoid having to re-enter certain information each time he or she inputs an encounter description, for example, his or her appearance. User profile information is discussed further below in relation to FIG. 3.

In some implementations, the matching engine 110 can formulate the query and execute the search automatically in response to a user inputting a new encounter description describing an encounter. In other implementations, the matching engine 110 can execute on a scheduled or as-needed basis, or in response to an event, such as a user request or receipt of a user payment.

The user device 112 can be any device operable to allow a user to interface with the system 102. For example, as discussed above, user input can be received in various different forms, including information uploaded to a website, audio signals, text messages, instant messages and e-mail messages. The user can interface with the system 102 using a telephone, personal digital assistant (PDA), laptop computer, personal computer, or any suitable device that allows the user to input and receive information regarding encounters. Because a user may interact with the system 102 using a mobile type of user device 112, the user can send and receive messages to and from the system 102 regarding an encounter in real time, for example, contemporaneously while the encounter is occurring.

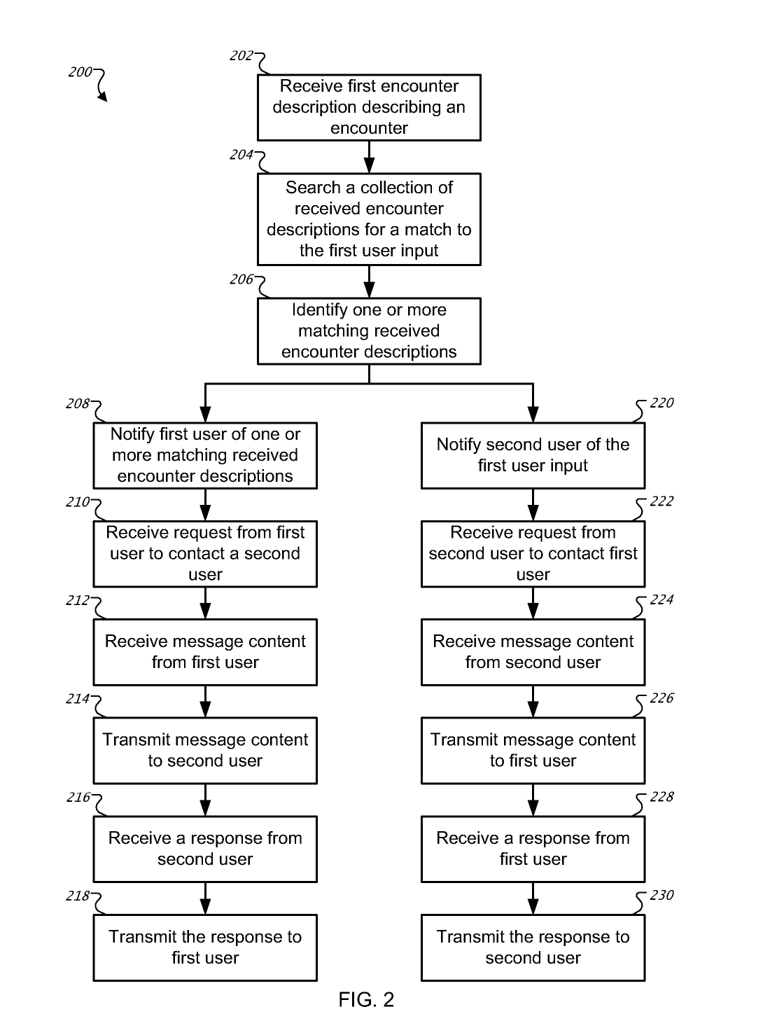

FIG. 2 is a flowchart showing an example process 200 for facilitating electronic communication between two users following an encounter. In one implementation, the process 200 can be implemented using the system 102 shown in FIG. 1, although in other implementations, a differently configured system 102 can be used. For illustrative purposes, the process 200 shall be described in reference to the system 102.

The process 200 starts in step 202 when a first encounter description describing an encounter between two people is received. For example, the input may come from a man named Bob who has exchanged glances with an interesting woman in a coffee shop. Bob can use a user device 112 to transmit a description of his encounter to the user interface 104. Bob can describe the encounter using input to aide the system 102 in matching his description of the encounter with that provided by the woman, should the woman also transmit a description of the encounter to the user interface 104. In one implementation, where the system 102 is implemented using a website, Bob can be required to become a registered member of the website before he can transmit a description of an encounter to the system 102. As part of the registration process, Bob can be required to input user profile information, which can be later used to facilitate the matching process, e.g., his physical description including height, weight and hair color.

In one implementation, where the system 102 is implemented using a website, Bob can be presented with a GUI including a template, or series of templates, that he can complete to provide the encounter description. The template can include a number of data fields requiring Bob to complete the fields with values. Completing the data fields can be facilitated with controls, e.g., drop down menus, radio boxes, check boxes and the like. Receiving the content describing the encounter in the form of values completing data fields can facilitate a subsequent formulation of a field-based query and can facilitate a field based search.

Referring again to FIG. 2, after receiving Bob's encounter description (i.e., the first encounter description), a collection of received encounter descriptions is searched for another encounter description with matching content (step 204). For example, the user interface 104 having received Bob's account of the encounter can transmit the first encounter description to the collection of received encounter descriptions 108, and the matching engine 108 can be invoked to perform a search of the collection of received encounter description 108. In one implementation, the matching engine 110 conducts the search in response to receiving the first encounter description via the user interface 104. The matching engine 108 can automatically formulate a query based on the first encounter description and, from the first user's perspective, the search occurs automatically without additional interaction from the first user after the first user has input their encounter description (i.e., the first encounter description).

One or more matching received encounter descriptions can be identified (step 206). For example, if an encounter description had already been received from the woman describing the encounter, then the woman's input should be identified as a match, assuming she described the encounter in a similar manner.

The first user, i.e., Bob, is notified of one or more matching received encounter descriptions (step 208). For example, the system 102 can notify Bob via the user interface 104 that a received encounter description has been identified from a second user, i.e., the woman, who is known by the alias “Sly_Sally”, that includes content matching his account of the encounter in the coffee shop. In one implementation, where the system 102 is implemented using a website, Bob can be notified of the matching received encounter description by a posting to his account, which he can access by logging in to the website using a unique user name and/or password. In another implementation, Bob can be notified of a matching received encounter description by receipt of an e-mail, text or instant message.

The first user can be provided an option to request contact with a user that provided a matching encounter description, i.e., the second user or in this example, the person operating under the alias Sly_Sally (step 210). For example, the system 102 can receive a request via the user interface 104 from the first user, Bob, to contact the second user, Sly_Sally.

If Bob has requested to contact the second user, then Bob is prompted to input message content that he would like passed on to the second user and the message content is received from Bob (step 212). For example, the system 102 can receive message content from the first user, Bob, via the user interface 104 in any of a variety of forms, e.g., website posting, e-mail, text message, etc.

The message directed to the second user, i.e., Sly_Sally, is transmitted to the second user (step 214). For example, the system 102 can transmit the message content to the second user via the user interface 104 as a posting to the second user's account (if the system is implemented as a website), as an e-mail message or other type of message. In one implementation, the system 102 may require a monetary payment from Bob before his message will be transmitted to the second user. In another implementation, by paying a flat membership fee (e.g., monthly fee), Bob can transmit encounter descriptions to the system 102, receive notifications of matches and communicates with user's providing the matching encounter descriptions while his membership is active.

A response may be received from the second user, e.g., Sly_Sally, to the message transmitted on behalf of the first user, Bob (step 216). For example, the system 102 can receive a response from the second user via the user interface 104.

The response received from the second user, Sly_Sally, is transmitted to the first user, Bob (step 218). For example, the system 102 can transmit the response to the first user via the user interface 104, e.g., as an e-mail, account posting, etc.

Steps 208 to 218 discussed above described the system's interaction with the first user, in this example, Bob. However, a parallel interaction can be ongoing with the second user, in this example, Sly_Sally, as well. That is, Sly_Sally also transmitted an encounter description to the system 102 describing an encounter and is also hopeful that one or more matching encounter descriptions will be identified. In this example, Sly_Sally was the first to transmit a description of the encounter to the system 102. Accordingly, her input (the “second encounter description”) was already in the collection of received encounter descriptions 108 when the first user, Bob, transmitted his description of the encounter to the system 102. As such, when Bob's encounter description was received and a search of the collection of received encounter descriptions 108 was conducted by the matching engine 110, Sly_Sally's encounter description was identified. By contrast, when Sly_Sally initially transmitted her encounter description and a search of the collection of received encounter descriptions 108 was conducted, Bob's encounter description was not located as it was not yet included in the collection. However, in one implementation, the system 102 can be configured to periodically, e.g., daily, re-query the collection of received encounter descriptions 108 for matches and notify user's of any new matches subsequently found. Alternatively, when the search is conducted that is prompted by Bob's encounter description, and a match is identified, the system 102 can automatically notify both affected users, i.e., the first user Bob and the second user Sly_Sally. In this implementation, Sly_Sally is promptly notified as soon as Bob's encounter description is received in the collection and a search conducted, rather than Sly_Sally having to wait until a next-scheduled routine updated search is conducted.

Referring again to FIG. 2, once the matching encounter descriptions of the first and second user are identified, both the first user and the second user are notified of the match (steps 208 and 220). For example, the system 102 can notify the second user, Sly_Sally, of the first encounter description via the user interface 104.

A request can be received from the second user, Sly_Sally, to contact the first user, Bob (step 222). For example, the system 102 can receive a request from the second user, Sly_Sally, via the user interface 104 to contact the first user.

The second user provides a message directed to the first user (step 224). For example, the system 102 can receive message content from the second user, Sly_Sally directed to Bob.

The message is transmitted to the first user, e.g., Bob (step 226). For example, the system 102 can transmit the message from Sly_Sally to Bob via the user interface 104, e.g., as an e-mail message or otherwise.

A response can be received from the first user, e.g., Bob, that is directed to the second user, e.g., Sly_Sally (step 228). For example, the system 102 can receive a response from Bob via the user interface 104 that is directed to Sly_Sally.

The response from the first user, e.g., Bob, is transmitted to the second user, e.g., Sly_Sally (step 230). For example, the system 102 can transmit the response via the user interface 104 to the second user. In this manner, an electronic communication between Bob and Sly_Sally is facilitated. Without the system 102, the parties could not have electronically communicated, as they did not have each other's contact information and, even if they did, may have been too inhibited to initiate contact without the anonymity provided by the system 102.

Referring to FIG. 3, example information that can be requested from a user is depicted in a table, to be referred to as a user profile table 302. In one implementation where the system 102 is implemented using a website, the user profile table 302 shows example information that a user can provide upon establishing membership, i.e., user profile information. The user profile information can be stored in the optional collection of user profiles 109 shown in FIG. 1.

The user profile table 302 is organized in three columns: a member information column 304, an instructions column 306, and an example column 308. The member information column 304 includes example data elements that the system 102 can use to define a user, such as a user ID, password, contact information, and personal data. The instructions column 306 includes user instructions corresponding to each data field defined in the member information column 304. The instructions may be presented to the user, for example, as prompts on a webpage displayed to a user interacting with the website, to which prompts the user can input corresponding information. The example column 308 includes, for illustrative purposes, examples of user inputs that can be received for each of the corresponding data fields.

In one implementation, the user profile information 304 is gathered from a user when a user first initiates an interaction with the system 102, for example, registering as a member of a website included in the system 102. While doing so, the user can follow field-by-field instructions, such as those shown in the instructions column 306. For example, a man entering his user ID 310 on the website can use an alias such as “Coffee_Guy” if he enjoys coffee or often frequents coffee shops. The system 102 can require that each new user ID be unique from existing ones.

In the implementation shown, the user profile information 304 also includes a password 312 and a contact e-mail address 314. The system 102 can use the supplied e-mail address to send communications to the user, e.g., periodic messages regarding membership information or notifications of matching encounter descriptions. In some implementations, the system 102 can also use the e-mail address to coordinate membership authorization, such as by sending the user an e-mail that is to be accessed before membership can be activated. The system 102 can also make the user's e-mail address available to other users that the user chooses to contact outside of the system site, once the system 102 has identified them as sharing an encounter.

The member information can further include a personal profile section 316 that can include fields such as gender, height, weight, age, geographical location (e.g., city, town state, ZIP/postal code). The user profile information 304 included in the personal profile section can serve to automatically populate certain fields of a future description made by the user of an encounter. That is, by entering such information in a user profile, the user can avoid having to re-enter this information each time he or she inputs an encounter description.

In one implementation, the user profile information 304 can be gathered using a GUI presented via a webpage, the GUI including one or more controls such as drop-down menus, option buttons, sliding bars, text boxes, or other controls that facilitate data entry. Application software supporting the user interface 104 can perform data verification, such as requiring that numeric fields contain numbers and not letters. In some implementations, user entry of some fields can automatically “complete” other fields, such as the common practice of entering a ZIP code to automatically determine and fill in the city and state fields. In some implementations, the system can periodically e-mail the user, providing a summary of the current values of the fields in the personal profile section, and asking for any corrections or updates, e.g., a change of address.

The user profile information 304 can optionally include a “desired accuracy level” 318 that identifies the degree of matching accuracy the user desires when the matching engine 110 searches for matching encounter descriptions. In one implementation, the desired accuracy level field has a valid range of values from 1 to 10, with 10 being the highest level and requiring the highest degree of matching content before an encounter description can be considered a match. For example, in one implementation, a desired accuracy level of 1 may require that only the location of encounters described in the received encounter descriptions match with the location of the encounter described by the user in his/her encounter description match in order for a matched encounter description to be declared, i.e., a low matching threshold. By contrast, a desired accuracy level of 10 may require that the content of every variable described by the user in his/her input match with content included in the received encounter descriptions before a matching received encounter description is declared.

In other implementations, the user profile information 304 can include more, fewer and/or different data fields. For example, additional fields requiring the user to input his or her frequent hang-outs, favorite stores or restaurants, or other such personal information which may be useful when attempting to match encounter descriptions, can be included in the user profile. In one implementation, the system 102 can update the user's profile with new locations the user frequents each time the user inputs an encounter description that describes an encounter that occurred at a location that is not already included in the user's list of “locations the user frequents”. As discussed further below, in some implementations, this information can be useful in matching a user profile to an encounter description.

Referring to column 308, in one example, a user named Bob Schwartz can register a membership on the system 102 by inputting an alias such as “Coffee_Guy” as his user ID and completing the remaining fields, providing values such as those shown in column 308. Some time after completion of the membership registration, Bob Schwartz may experience an encounter deemed worthy by Bob of inputting to the system 102. By way of illustrative example, Bob may be sitting in a coffee shop on a Friday night when he connects eyes with an interesting-looking woman seated at a distant table. In particular, the woman of interest may end up leaving the coffee shop before Bob has the chance to meet her and ask her name. Upon returning home later that evening, Bob can use his home computer, for example, to access a website included in the system 102, and enter an encounter description describing his recent encounter.

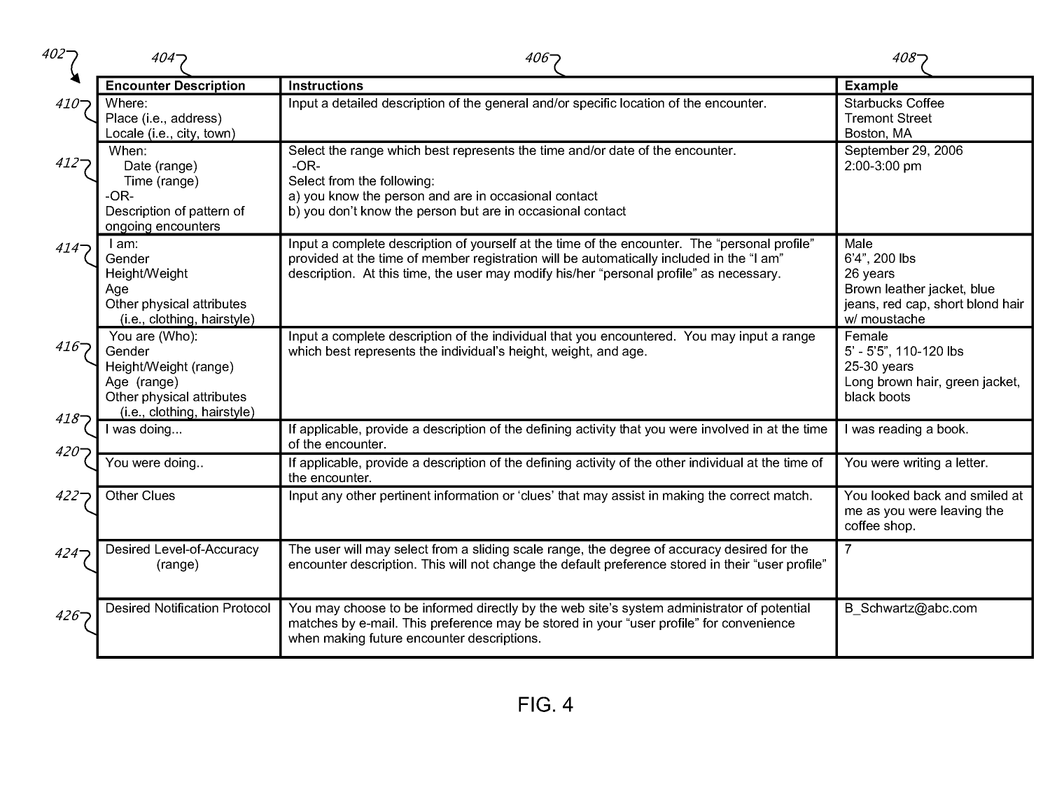

Referring to FIG. 4, example encounter description information is depicted in table, which shall be referred to herein as an encounter description table 402. The encounter description table 402 includes three columns: an encounter description column 404, an instructions column 406, and an example column 408. The table is further organized by rows, each of which corresponds to a group of data fields (e.g., “Where: Place . . . Locale”). The encounter description column 404 includes the information that can be requested from a user in one implementation when the user is inputting an encounter description to the system 102. The instructions column 406 includes instructions that can be provided to the user in one implementation when prompting the user for the requested encounter description information. The examples column 408 provides for illustrative purposes examples of encounter description input that can be received from a user.

In one implementation, the system 102 includes one or more GUIs presented to a user on one or more webpages, where a GUI includes controls for entering the encounter description information. For example, upon selecting a control on the website to post an encounter description describing an encounter, the user can be prompted with fields, such as the “Place” and “Locale” to document where the encounter occurred. The process can continue until the user has supplied all of the requested encounter description information.

By way of illustration, referring to the previous example, Bob Schwartz can input encounter description information to describe his coffee shop encounter with the interesting woman. By interacting with one or more GUIs provided by the user interface 104, Bob can input where the encounter occurred (See row 410), e.g., “Starbucks Coffee, Tremont Street, Boston, MA Starbucks”, and when the encounter occurred (See row 412), e.g. “Sep. 29, 2006, 2:00-3:00 pm”. Bob can also provide personal details about himself (See row 414), such as gender, height, weight, and other physical attributes that can be helpful when trying to match Bob's description of the encounter with a description provided by another user. In one implementation, the system 102 can populate certain data fields based on inputs Bob provided earlier when completing his personal profile, such as those listed in the user profile table 302. In addition, Bob can input additional personal information, such as a specific appearance description (e.g., “Brown leather jacket, blue jeans, red cap, short blond hair with moustache”). Bob also can enter a similar set of information describing the woman he saw in the coffee shop (see Row 416), e.g., “Female; 5′-5′5″”, 110-120 lbs; 25-30 years; long brown hair, green jacket, black boots”.

In some implementations, the system 102 can allow the entry of special values in place of certain fields. For example, in lieu of or in addition to requiring the user to specify date and time values, the system can make available time-independent categories for the “when” field, such as “you know the person and are in occasional contact” and “you don't know the person but are in occasional contact.” In addition, the system 102 may allow the user to enter ranges of certain fields, such as encounter dates/times or personal information (e.g., weight), which can increase the chances of matching encounter descriptions when values are not known.

Referring to row 418, Bob can be prompted to specify what “I was doing . . . ” and in this example inputs “I was reading a book.” Referring to row 420, to describe what the interesting woman was doing at the time, Bob can be prompted to specify what “Your were doing . . . ” and in this example inputs “You were writing a letter”. In the illustrative implementation being described, Bob can also be prompted to enter other clues (see row 422), e.g., “You looked back and smiled at me as you were leaving the coffee shop.”

In some implementations, the user can be prompted for additional information regarding the encounter, such as specific keywords that may have come up in conversation, or license plate numbers (e.g., for car-to-car sightings on the freeway).

To aide in improving the quality of matching encounter descriptions, the user can be prompted to select a desired accuracy level, or accuracy range, for which the user wants the system 102 to match encounter descriptions (see row 424). In one implementation, the system 102 can populate the desired level of accuracy field using the user's default preference stored in the user's personal profile.

Referring to row 426, the user can be prompted to indicate his or her desired notification protocol for receiving notification from the system 102 when a matched encounter description is identified. In this example, Bob has elected to be notified by e-mail to his e-mail address B_Schwartz@abc.com.

The encounter description information 404 described in FIG. 4 is not exhaustive. In other implementations, more, less and/or different information can be requested from the user. Some examples of additional information that can be requested include: a description of what the user said during the encounter; a description of what the other person said during the encounter; and/or the context in which the encounter occurred.

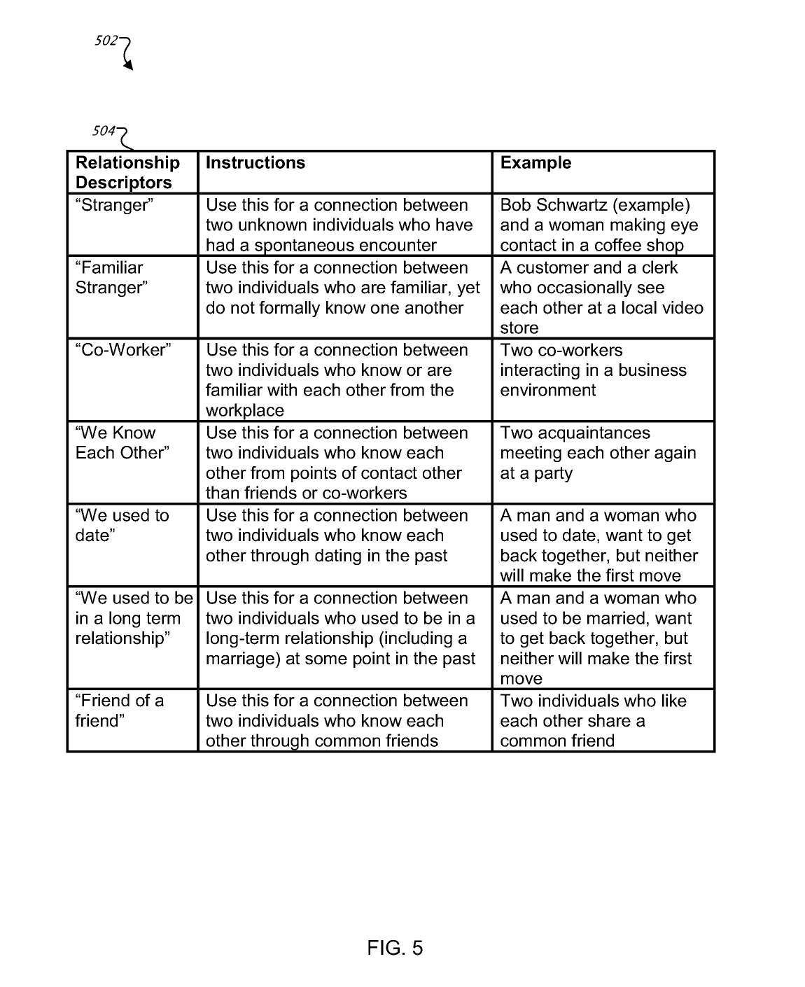

Referring to FIG. 5, a table 502 is shown including another example of additional information that can be requested from the user when inputting the encounter description information. This additional information provides an additional variable that can be used by the matching engine 110 when searching for matching content. Column 504 includes a set of relationship descriptors that aim to quickly categorize the relationship between the user inputting the encounter description and the other person involved in the encounter. The set of relationship descriptors included in column 504 is not exhaustive and more or fewer descriptors can be provided. Referring to column 504, the relationship descriptors can include relationship types such as “Stranger,” “Familiar Stranger,” “Co-Worker,” “We Know Each Other,” “We used to date,” “We used to be in a long term relationship,” and “Friend of a friend.” Other examples of relationship descriptors include “Long-lost friends,” “Past lovers,” and “War buddies.”

The system 102 can be implemented to enable the user to simply select from one of the available relationship descriptors defined in the system, or to provide another one. Selection of a relationship descriptor can be facilitated by the user interface 104, such as by using a combination of pull-down lists, text boxes, or other controls. For example, Bob can use a pull-down list to select “Stranger” for his encounter, or he can select a different option, or type in his own.

Once a user has input the requested encounter description information, it is up to the other party involved in the encounter to also input an encounter description in order for the two parties to be electronically connected. In one implementation, more than two people can be involved in an encounter. As long as at least two of the people involved input an encounter description, a match between at least those two people can be made.

Referring again to the above example, after Bob has input his description of the encounter involving the woman at the coffee shop, he can hope that she does the same. The process that the coffee shop woman can use to input her description of the encounter is similar to the process followed by Bob as described above. For example, in an implementation where the system 102 is implemented using a website available to registered members, after becoming a registered member of the website (if not already a member), the woman can further use the website to input her description. The information that the woman inputs to describe the encounter is from her point-of-view, and much of the content she inputs can be expected to match Bob's content. However, she may remember the encounter in a slightly different way, such as not remembering the exact date or time of the encounter, but narrowing it to a range of dates. Similarly, her memory of what she and the man were wearing that night may be hazy. Nevertheless, the matching engine 110 included in the system 102 can use the information that both users (e.g., Bob and the coffee shop woman) input into the system, in addition to their desired accuracy levels, and produce a match.

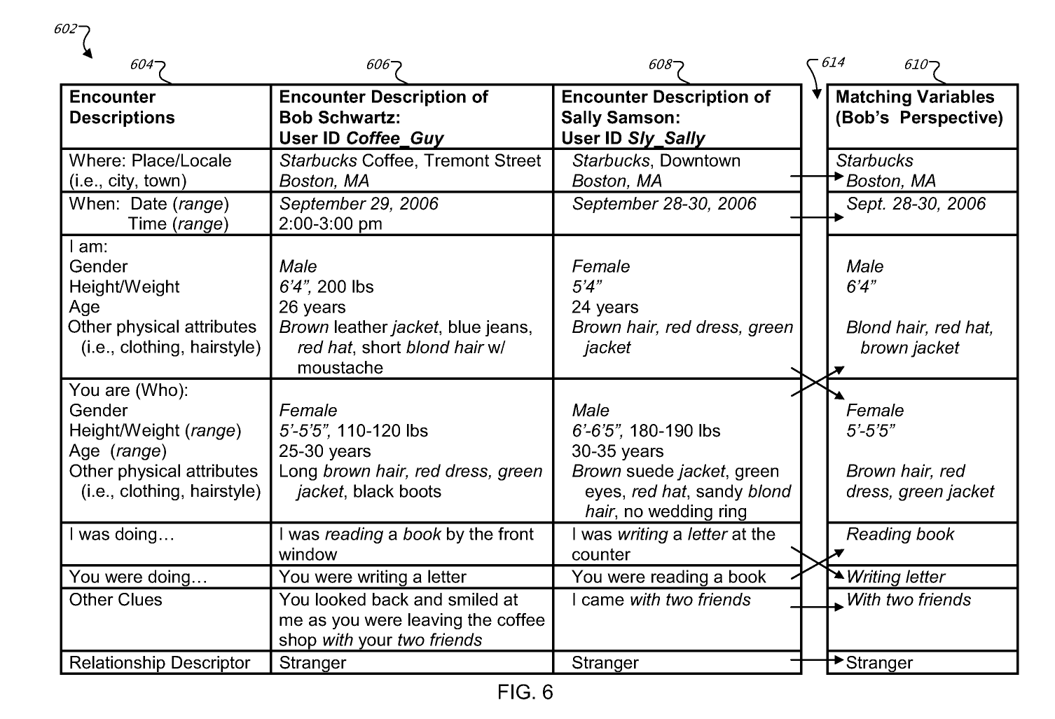

Referring to FIG. 6, for illustrative purposes the encounter description information input by Bob is compared to the encounter description information input by Sally in a tabular form. The table 602 includes four columns: an encounter description column 604, Bob's input information column 606, Sally's input information column 608, and a matching variables column 610.

The matching variables column 610 identifies the variables in common between Bob and Sally's encounter descriptions, as set forth in columns 606 and 608. That is, the information that was included in Bob's encounter description that matches the information included in Sally's encounter description is detailed in the matching variables column 610. In particular, the variables shown describe an encounter at “Starbucks” between “Sep. 28-30, 2006” with a “Female” having “Long brown hair, red dress, green jacket,” which closely matches Bob's (and Sally's ) encounter description. Areas of similarities between Sally's encounter description and the matching variables column 610 are indicated by arrows 614.

In one implementation wherein a field-based query is used, points are assigned to each data field and a score can be determined for an encounter description by adding up the points for each data field that includes content matching the search query. The higher the score, the better the encounter description matches the encounter description upon which the search query is based. In one implementation, natural language matching algorithms are used to calculate degrees of similarity between text fields, which can be factored in to the score calculation. In another implementation, the matching engine 110 requires that at least certain fields match before a first encounter description can be identified as matching (or potentially matching) a second encounter description. Optionally, a score can then be calculated for each of the potentially matching encounter descriptions, as described above to further narrow and/or rank the matches identified. In one example, the mandatory matching fields include the date field, location field, city field, and gender field. In one implementation, the desired accuracy level discussed above can be implemented by having each level correspond to a range of scores. The desired accuracy level can be user selected, as described, or in another implementation can be set by the system 102.

As discussed above, an advantage to receiving the content of the encounter description as values completing various data fields and formulating a field based query based on the encounter description is that the number of false matches can be reduced. In the above example, the query is looking for someone that was “writing a letter”, that is, the author of the encounter description is the person that was writing the letter. If an encounter description is found where the author had an encounter with someone else that was “writing a letter”, then (depending on the desired accuracy level of the search) a match will not be declared because the author was not writing the letter. However, if the search was not field based, then the inclusion of the words “writing a letter” in the encounter description could easily lead to false matches, such as the example provided above (i.e., where it wasn't the author but the person the author encountered that was writing the letter).

Once a match has been identified between two similar encounter descriptions describing an encounter, for example, the match between Bob's and Sally's encounter descriptions illustrated in table 602, the system 102 can contact one or more of the users associated with the match. In one implementation, the user interface 104 sends an e-mail to the first user, Bob, notifying him of the match with Sally's input. Additionally, Sally can be notified of the match with Bob's input.

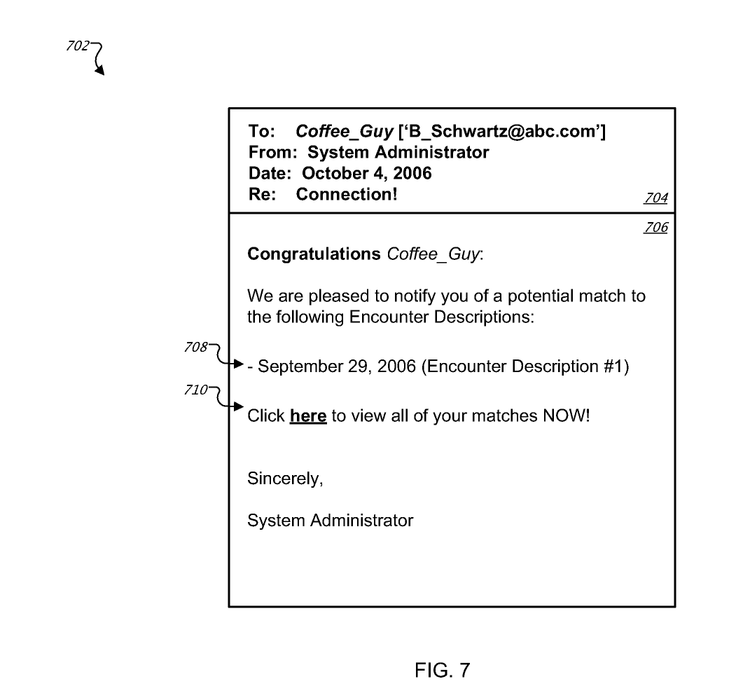

Referring to FIG. 7, an example implementation of a connection message 702 that the system 102 can send to notify the first user of a match to the first user's encounter description is shown. In one implementation, as shown, the connection message can be in the form of an email message that the user receives on the user's home computer (i.e., user device 112). The e-mail message can include a header 704, identifying the subject of the e-mail message, and a message body 706 providing information about the match. As already discussed above, in other implementations the first user can be notified of the match in another manner, for example, via a text message, audio message, instant message and/or a posting to the user's account if the system 102 includes a website.

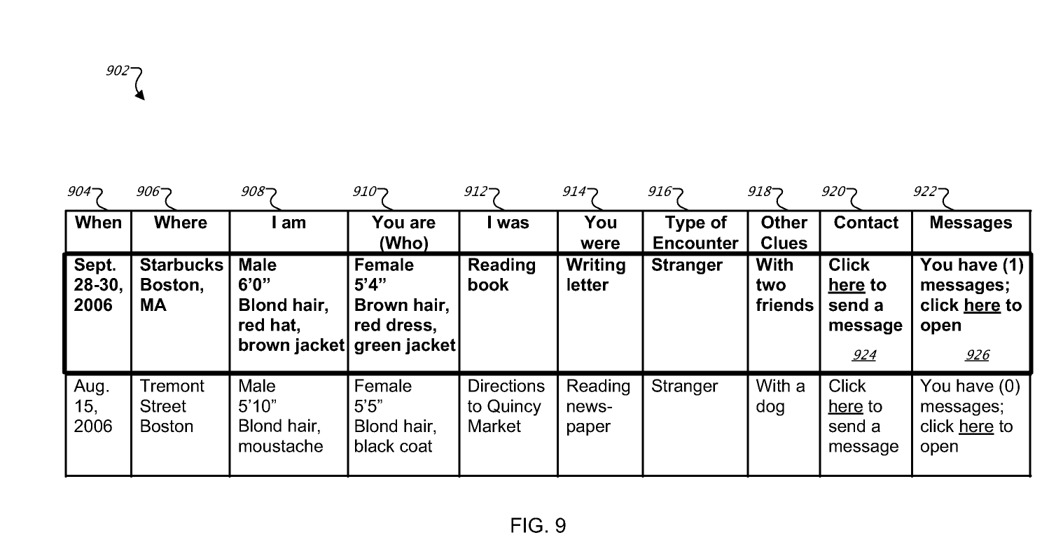

In this implementation, the message body 706 includes information 708 identifying the date the encounter description was input by the user and a clickable prompt 710 to allow the user to view the matches identified. In this example, Bob (also known by his user ID alias of “Coffee_Guy”) receives the connection message 702 regarding “Sep. 29, 2006 (Encounter Description #1),” and he can click on the “Click here to view all of your matches NOW!” clickable prompt 710 to view the matches to the identified encounter description. An example of the information that the system 102 provides when the user clicks the clickable prompt 710 is described below in reference to FIG. 9.

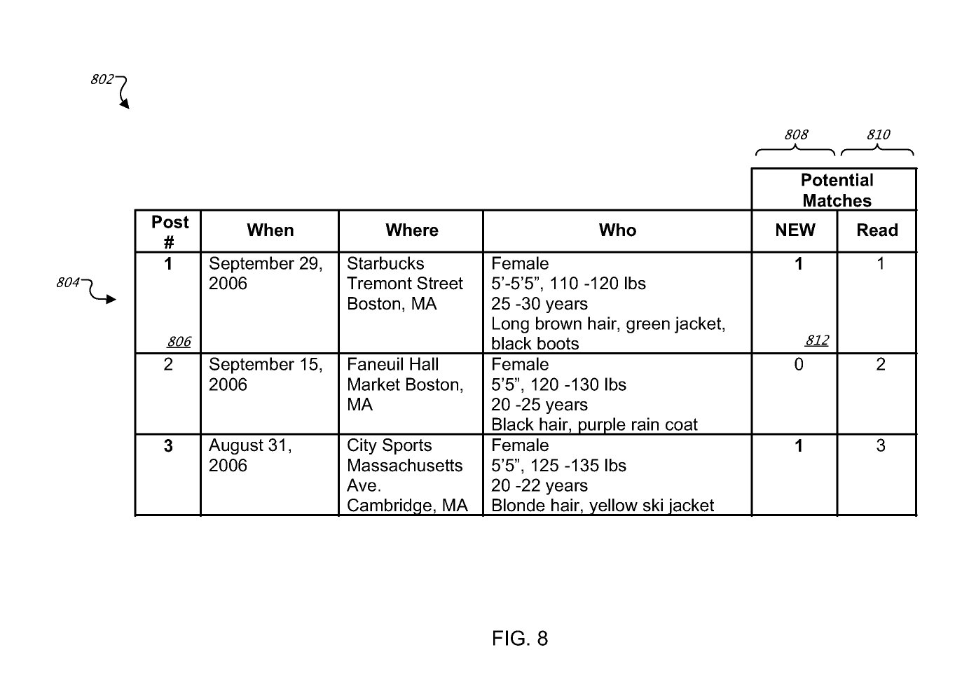

FIG. 8 shows the type of encounter description information that can be presented to a user of the system 102 in one implementation. For example, if the system 102 includes a website and the user is a registered user of the website, upon logging into the website, the user can be presented with a GUI providing the user's encounter description information shown in a table format (for illustrative purposes) in FIG. 8. The table shown can be referred to as a postings scorecard 802 that summarizes the user's history of previously input encounter descriptions. Each row of the postings scorecard 802 represents one encounter description. For example, row 804 represents the encounter description input by Bob discussed in the example above.

In this implementation, the user can elect to view additional details of the encounter description by clicking on the post number, e.g., the number “1” or other similar control in the cell 806. Columns 808 and 810 provide the user with information about potential matches to each encounter description. For example, the “1” in cell 812 of the “Potential Matches—NEW” column indicates that one new potential match has yet to be read by the user. The number “1” in the cell 814 indicates that one potential match exists that the user has already read. Clicking on the “1” in cell 812 can display the new (e.g., unread) potential matches, as well as the previously read potential matches that are indicated in the “Potential Matches—Read” column 810.

Referring to FIG. 9, an example of information that can be presented to the user upon clicking the cell 812 to review the new potential match is shown. Similarly, this information can be presented in response to the user clicking the link 710 in the connection message 702 shown in FIG. 7. The information can be presented in a GUI on a webpage, for example, and is shown for illustrative purposes in the table 902. The display can also include information about potential matches that have already been read by the user. A “new” potential match can be displayed differently than the previously read matches, e.g., by highlighting or bolding new (unread) matches, and then changing their display style to that of previously read entries once they are read. The information included in each row in columns 904-922 is populated with data parsed from a particular second user's encounter description, for example, the first row includes information from Sly_Sally's encounter description.

In some implementations, the information displayed can include a ranking, indicating the degree of variable matching between the two encounter descriptions. For example, if Bob set his desired accuracy level for matches to a particular encounter description at 7, then the potential matches automatically detected by the system 102 can include matches meeting or exceeding a “7” accuracy level. Incorporating ranking information in the information provided to Bob can help Bob to quickly identify the potential matches meeting the higher accuracy levels (e.g., 9 or 10). This can be useful if Bob generally “casts a wide net” by setting his desired accuracy level at a low level. In another implementation, the ranking information is not provided, however, the potential matches are displayed to the user in order by ranking, for example, the more accurate matches being displayed first.

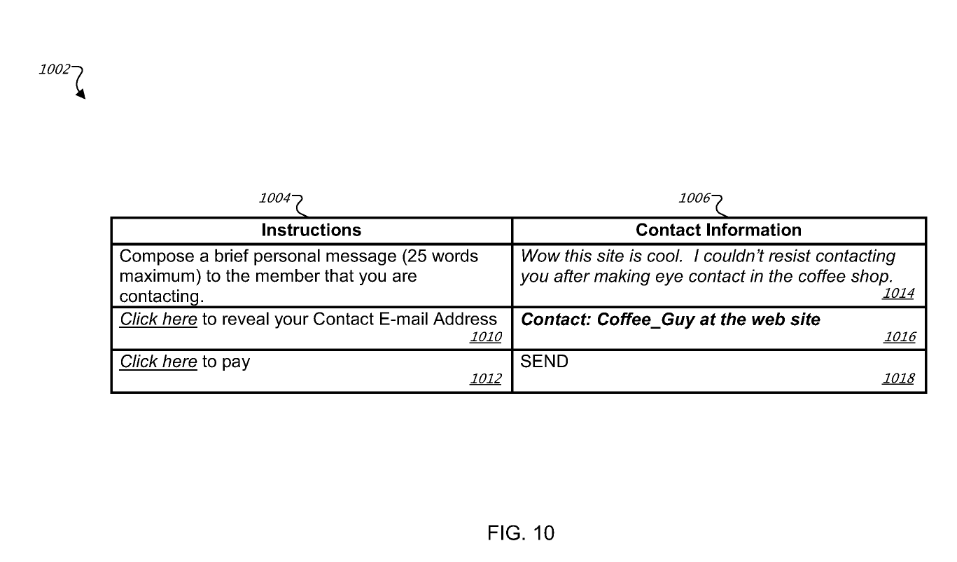

Referring again to FIG. 9, the information presented to the user can include links to send a message or to view a message. In the implementation shown, the “Contact” column 906 includes a user-selectable control (e.g., a clickable link) for sending a message to the other matched user. For example, if Bob wants to send an e-mail to the woman associated with his Sep. 29, 2006 encounter description, he can select the “Click here to send a message” control shown in cell 924. When Bob selects such a control, the system 102 can display a GUI that allows Bob to draft a message to the woman. One example of such a GUI is shown in FIG. 10.

Referring now to column 906 in FIG. 9, a “Messages” column can include a user-selectable control (e.g., a clickable link) for viewing messages received from the other matched user. For example, if Bob wants to view a message received from the woman associated with his Sep. 29, 2006 encounter description that is either in response to his message to her or a message initiated by the woman, he can select the “You have (1) message(s); click here to open” control shown in cell 926. When Bob selects such a control, the system 102 can display the message received from the woman.

FIG. 10 is an example of information that can be included in a GUI and presented to a user to compose a message to user that authored a matching encounter description. For example, Bob can use the interface 1002 to compose a message to the woman, Sly_Sally, matching his Sep. 29, 2006 encounter description. Bob can be provided with this screen, for example, after selecting the “Click here to send a message” control in cell 924 shown in FIG. 9.

In this implementation, an instructions column 1004 includes instructions for the user to follow when drafting the message, e.g., a word-count limitation. In this example, Bob drafts the message “Wow this site is cool . . . ”, as shown in the contact information column 1006 at cell 1014. In this implementation, by default, Sly_Sally will not be provided with Bob's e-mail address, but rather will be provided with his user ID alias, Coffee_Guy, as shown in cell 1016 of column 1006. However, Bob can opt to have his e-mail address provided to Sly_Sally, for example by clicking in cell 1010, so that in future communications she can elect to correspond with him directly rather than through the system 102. In one implementation, a payment is required by a user before a message will be sent to another user. For example, Bob can pay a fee by selecting the “Click here to pay” control shown in cell 1012. After Bob submits a payment, such as by credit card or other electronic payment, the system can display a control, such as a “SEND” button 1018, that Bob can select to send his e-mail message. Other optional fee models are possible and the one just described is one illustrative example.

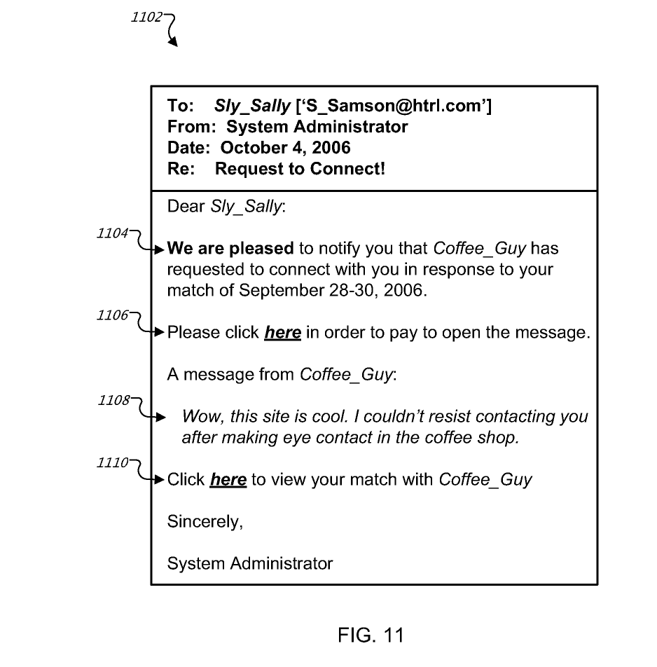

FIG. 11 is an example of a connection message 1102 received by Sly_Sally from the system 102 on behalf of Coffee_Guy, i.e., Bob. In this implementation, the message 1102 includes a statement 1104 notifying the e-mail recipient that Coffee_Guy has requested to connect with the recipient, i.e., Sly_Sally in response to their matched encounter descriptions. Sly_Sally is already aware there was a match with Coffee_Guy, since she would have previously been informed of the match once the match was identified. In this implementation, the payment model requires that Sly_Sally to pay before she can review the message from Coffee_Guy, and includes a payment prompt 1106 (i.e., the message 1108 is not revealed to Sly_Sally until payment is received). If she selects the payment prompt 1106 and provides payment, then the message 1102 further displays the message 1108 from Coffee_Guy. In this implementation, Sally is provided a view match control 1110, which can be used to access the information she was previously provided about the matching encounter description provided by Coffee_Guy. Communication between the users, such as messages between Bob and Sally, can remain anonymous until either party decides to share a personal e-mail address or other personal contact information.

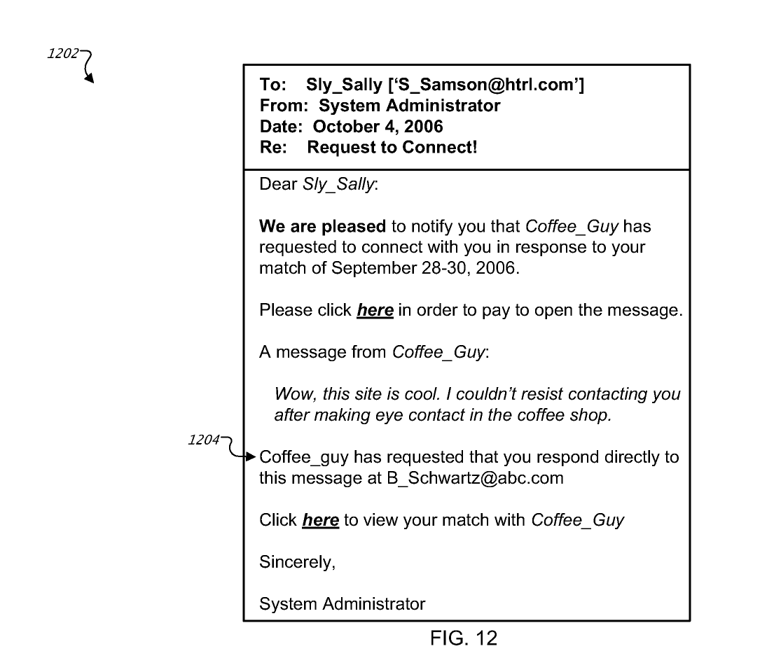

FIG. 12 is an alternative example connection message 1202 sent from Coffee_Guy to Sly_Sally, wherein Coffee_Guy has elected to provide Sly_Sally his personal e-mail address “B_Schwartz@abc.com”, which Sally can now use to correspond directly with Bob at her option (see 1204). In some implementations, the system 102 may not provide the user with another user's personal e-mail address until an additional fee is paid.

An implementation has already been discussed above wherein the search query is formulated based on both the first user's first encounter description and the first user's profile. In one implementation, the optional collection of user profiles 109 is searched in conjunction with the collection of received encounter descriptions 108. That is, when each encounter description included in the collection 108 is being compared to the first encounter description, personal information about the author of the each encounter description being considered can be retrieved from the author's user profile that is stored in the optional collection of user profiles 109.For illustrative purposes, one implementation of a matching algorithm shall be described below. However, this is but one example, and it should be understood other matching algorithms can be used. An encounter description can include a set of “required” (primary) data fields, which in this example include: frequency of encounter, date, time, country, state/province, city, context description (e.g., coffee shop), location name (e.g., Java Joe's ), and gender of other party. The encounter description can also include one or more optional data fields that describe permanent physical attributes of the person (the “Secondary Set A”) including, for example: build of other party (e.g., slim), hair color of other party, ethnicity of other party, eye color of other party, age of other party, tattoos of other party and body piercings of other party. The encounter description can also include one or more optional data fields that provide more detail about the parties involved during the encounter (the “Secondary Set B”) including, for example: “what I was wearing”, “what I was doing”, “what I said”, “what you were wearing”, “what you were doing”, “what you said”, and a general encounter description.

The process of assembling matches for a new encounter description (e.g., the “first encounter description”) will be as follows:

1. The primary data fields of the first encounter description are compared to the corresponding primary data fields of all other encounter descriptions stored in the collection of received encounter descriptions 108. In one implementation, the “gender of the other party” field can be compared to the gender of the author of an encounter description as retrieved from the author's user profile stored in the optional collection of user profiles 109. A set of candidate matching encounter descriptions (the “candidates”) is chosen from the collection of received encounter descriptions 108 based on the following criteria:

a. the frequency of encounter must match exactly;

b. in the case of “one time” frequency, the date and time must match within a system defined tolerance (e.g., 4 hours), otherwise date and time are not provided by the user;

c. the city must match exactly;

d. the context description must match exactly;

e. the location name must match approximately;
i. keywords from the two user provided locations are compared to establish a minimal level of likeness; and
ii. a Soundex function is applied to the keywords to minimize matching errors related to misspellings; and

f. the gender of the other party must match the gender of the author of the encounter description (which gender information can be retrieved from the author's user profile).

2. The set of candidates is then further analyzed to assess the quality of the match. The quality can be defined as a score between 0 and 1, where 0 represents an invalid match and 1 represents a perfect match. The score of a candidate can be determined based on the following criteria:

a. The Secondary Set A data fields of the first encounter description pertaining to the permanent physical attributes of the person are compared with the corresponding fields in either the candidate encounter description or in the user profile of the author of a candidate encounter description. Each field has a weighting number that is predefined in the system. This weighting is added to the candidate score when the fields match. If the fields do not match exactly, then the weighting number is not added to the candidate score.

b. The Secondary Set B data fields of the first encounter description are compared with the corresponding fields in each candidate encounter. Generally, these fields are natural language fields entered by the users so they are less likely to have an exact match. Two corresponding fields are compared for similarities in the keywords and phrases included in the data and are given a score between 0 and 1 indicating the likeness of the data. This score is multiplied by a system defined weighting for the particular data field, and the result is added to the candidate score.

c. The total score for each candidate is then expressed as a score between 0 and 1 by dividing the cumulative candidate score by the total possible score based on system defined weightings for all data fields.

3. A system defined threshold for minimum quality of a match can be defined in the matching engine 110. A user defined threshold for minimum quality of a match can also be defined in the system 102. These thresholds are stored in the system as a number between 0 and 1. If a user defined threshold for minimum quality exists, then any candidate with a score above that number is identified as a match to the first encounter description. If a user defined threshold for minimum quality does not exist, then the candidate score must be above the system defined threshold for minimum quality to be identified as a match for the first encounter description.

The score determined for each match to the first encounter description can be stored in the system 102 and used to order the matches (e.g., from highest to lowest) when transmitted to and viewed by the first user. The scores may or may not be provided to the first user.

In another implementation, the optional collection of user profiles 109 can be used when conducting the search for the following different reason. It is possible that the person that shared the encounter with the first user, i.e., the second user, is a user of the system 102 and has a user profile stored in the optional collection of user profiles 109, however, that person may not have entered an encounter description into the system 102 for this particular encounter. There may be enough information in the second user's profile to identify a match to the first encounter description. By way of illustration, consider the example of Bob and Sally discussed above. If Sally had not yet entered her encounter description into the system 102 by the time Bob entered his (i.e., the first encounter description), but Sally's user profile included enough information about Sally to match Bob's encounter description (e.g., her appearance, her gender, her favorite coffee shop, and her city of residence), then Sally's user profile can be identified by the system 102 as a profile of a user that may be the other person encountered by Bob. Depending on the anonymity provided by the system 102, either Sally's user profile can be provided to Bob, or a portion thereof, or the system 102 can provide a means for Bob to send a message to Sally via the system 102 without revealing her user profile to Bob. In one implementation, the first user has the option of searching one or both of the collection of encounter descriptions 108 and the optional collection of user profiles 109.

In another implementation, the encounter descriptions included in the collection of received encounter descriptions 108 can be made accessible to other users of the system 102. A user can browse the collection of received encounter descriptions 108, either to look for a description of a particular encounter or out of interest. In one implementation, a user can initiate contact through the system 108 with the author of an encounter description the user has read while browsing the collection.

In one implementation, the process and system described above can be implemented in conjunction with a payment model, which has been discussed in part already. In one payment model, a user must register with the system before the user can input encounter descriptions and subsequently is charged fees at various junctures. For example, the user can be charged a fee to input an encounter description, to send a message to a user that input a matching encounter description, to receive a message from a user that input a matching encounter description, and/or to provide the user's direct contact information to a user that input a matching encounter description. In another payment model, a user must register with the system and pay a membership fee before the user can input encounter descriptions and send and receive messages with the system 102. For example, the user can pay a monthly fee for an active membership and for as long as the membership is active, the user can input encounter descriptions, receive notifications of matches, and communicate anonymously with other users through the system 102. Other payment models are possible, and the ones described above are illustrative and not exhaustive.

An engine, as the term is used throughout this application, can be a piece of hardware that encapsulates a function, can be firmware or can be a software application or can be a combination of the above. An engine can perform one or more functions, and one piece of hardware, firmware or software can perform the functions of more than one of the engines described herein. Similarly, more than one piece of hardware, firmware and/or software can be used to perform the function of a single engine described herein.

The invention and the functional operations described in this specification can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output.

The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language.

Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; a magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

To provide for interaction with a user, the invention can be implemented on a computer system having a display device, e.g., a monitor or LCD screen, for displaying information to the user and a user input device, e.g., a keyboard and a pointing device such as a mouse or a trackball, by which the user can provide input to the computer system. The computer system can be programmed to provide a graphical user interface through which computer programs interact with users.

A number of embodiments of the invention have been described. Nevertheless, it will be understood that various modifications may be made without departing from the spirit and scope of the invention. Accordingly, other embodiments are within the scope of the following claims.

What is claimed is:

1. A computer implemented method for facilitating an electronic communication between a first and a second user, comprising:
receiving a first encounter description from a first user, the first encounter description comprising content describing an encounter between the first user and a second user;
formulating a search query based on the first encounter description;
using the search query to search a collection of received encounter descriptions to match at least some of the content of the first encounter description with content of one or more other received encounter descriptions;
identifying one or more other received encounter descriptions matching at least some of the content of the first encounter description based on the search, including a second encounter description from the second user comprising content describing the encounter between the first user and the second user; and
providing notification to the first user of the second encounter description.

2. The method of claim 1, wherein formulating the search query is in response to receiving the first encounter description.

3. The method of claim 1, further comprising:
adding the first encounter description to the collection of received encounter descriptions.

4. The method of claim 1, wherein an encounter description includes a time of the encounter, a location of the encounter and the gender of the second user.

5. The method of claim 1, further comprising:
receiving a first user profile from the first user, where the user profile includes personal information about the first user; and
wherein formulating the search query comprises formulating the search query based on the first encounter description and the first user profile.

6. The method of claim 1, further comprising:
receiving a request from the first user to contact the second user; and
receiving a message input from the first user and transmitting the message input to the second user.

7. The method of claim 6, further comprising:
receiving a response from the second user to the message input of the first user; and
transmitting the response from the second user to the first user.

8. The method of claim 1, further comprising:
providing notification to the second user of the first encounter description.

9. The method of claim 8, further comprising:
receiving a request from the second user to contact the first user; and
receiving a message input from the second user and transmitting the message input to the first user.

10. The method of claim 9, further comprising:
receiving a response from the first user to the message input of the second user; and
transmitting the response from the first user to the second user.

11. The method of claim 1, wherein receiving a first encounter description from a first user comprises receiving at least one of the following from the first user: a text message, an email message, an instant message, an audio message, a communication through a mobile application installed on a mobile device, or a posting to a website.

12. The method of claim 11, wherein receiving a first encounter description from a first user comprises receiving an audio message from the first user and translating the audio message into text.

13. The method of claim 1, wherein the encounter between the first user and the second user comprises a sighting between the first and second users.

14. The method of claim 1, wherein the encounter between the first user and the second user comprises an interaction between the first and second users.

15. The method of claim 1, wherein the encounter between the first user and the second user comprises a past or current relationship between the first and second users.

16. The method of claim 1, wherein the encounter between the first user and the second user comprises an in-person connection between the first and second users.

17. The method of claim 1, wherein providing notification to the first user of the second encounter description comprises providing at least one of the following to the first user: a text message, an instant message, an email message, an audio message, a communication through a mobile application installed on a mobile device, or a textual display on a graphical user interface of a webpage displayed to the first user.

18. The method of claim 1, wherein using the search query to search a collection of received encounter descriptions to match the content of the first encounter description with content of one or more other received encounter descriptions comprises performing a text-based search of the collection of received encounter descriptions for content satisfying one or more search criteria based on the content of the first encounter description.

19. The method of claim 1, wherein:
the first encounter description comprising content describing an encounter between the first user and a second user includes a plurality of values completing a plurality of data fields;
formulating a search query based on the first encounter description comprises formulating a field-based query based on the plurality of data fields; and
using the search query to query the collection of received encounter descriptions comprises using the field-based query to query the plurality of data fields included in each of the received encounter descriptions on a field-by-field basis.

20. The method of claim 19, wherein:
using the search query further comprises using the search query to query a plurality of data fields included in user profiles included in a collection of user profiles, where each encounter description included in the collection of received encounter descriptions corresponds to a user profile included in the collection of user profiles.

21. The method of claim 1, further comprising:
receiving from the first user a selection of a desired accuracy level; and
using the desired accuracy level and the search query to search the collection of received encounter descriptions and identify matching encounter descriptions.

22. A system for facilitating an electronic communication between a first and a second user, comprising:
a user interface configured to:
receive an encounter description from a user including a first encounter description received from a first user comprising content describing an encounter between the first user and a second user;
provide notification to the first user of a second encounter description including content describing the encounter between the first user and the second user;
a collection of received encounter descriptions, each encounter description including content describing an encounter between two different users; and
a matching engine configured to formulate a query based on the first encounter description and to use the search query to search the collection of received encounter descriptions for one or more received encounter descriptions including content matching at least some of the content of the first encounter description.

23. The system of claim 22, further comprising:
a collection of user profiles, each user profile including personal information about a user and the collection including a first user's profile corresponding to the first user;
wherein, the matching engine is further configured to formulate the query based on both the first encounter description and the first user's profile.

24. The system of claim 23, wherein:
the matching engine is further configured to use the search query to search both the collection of received encounter descriptions and the collection of user profiles for one or more received encounter descriptions and corresponding user profiles that include content matching at least some of the content of the first encounter description.

25. The system of claim 22, wherein the user interface is configured to receive an encounter description comprising at least one of the following: a text message, an email message, an instant message, a website posting, a communication from a mobile application installed on a mobile device or an audio message.

26. The system of claim 25, wherein if the user interface is configured to receive an encounter description comprising an audio message, the system further comprises:
an audio translation engine configured to translate the audio message into text.

27. The system of claim 22, wherein the user interface is configured to provide notification to the first user by providing at least one of the following to the first user: a text message, an email message, an instant message, an audio message, a communication to a mobile application installed on a mobile device, or a textual display on a graphical user interface of a webpage displayed to the first user.

28. The system of claim 22, wherein the encounter between the first user and the second user comprises a sighting between the first and second users.

29. The system of claim 22, wherein the encounter between the first user and the second user comprises an interaction between the first and second users.

30. The system of claim 22, wherein the encounter between the first user and the second user comprises a past or current relationship between the first and second users.

31. The system of claim 22, wherein the encounter between the first user and the second user comprises an in-person connection between the first and second users.

32. A computer implemented method for facilitating an electronic communication between a first and a second user, comprising:
receiving a first encounter description from a first user, the first encounter description comprising content describing an encounter between the first user and a second user;
formulating a search query based on the first encounter description;
using the search query to search a collection of user profiles to match at least some of the content of the first encounter description with content included in one or more user profiles, where a user profile comprises personal information about a user;
identifying one or more user profiles matching at least some of the content of the first encounter description based on the search, including a second user's profile for the second user comprising content matching at least some of the content of the first encounter description; and
providing notification to the first user of a match to the second user.

33. The method of claim 32, wherein:
the first encounter description comprising content describing an encounter between the first user and a second user includes a plurality of values completing a plurality of encounter description data fields and a user profile includes a plurality of values completing a plurality of user profile data fields and at least some of the encounter description data fields correspond to the user profile data fields;
formulating a search query based on the first encounter description comprises formulating a field-based query based on the plurality of encounter description data fields; and
using the search query to query the collection of user profiles comprises using the field-based query to query the user profile data fields corresponding to the encounter description data fields on a field-by-field basis.

34. The method of claim 32, further comprising:
providing notification to the second user of a match of the second user's profile to the first encounter description.
